(19) United States
(12) Patent Application Publication
(10) Pub. No.: US 2026/0319749 A1
(43) Pub. Date: Oct. 15, 2026

(54) ANALOG CIRCUIT-BASED RANDOM NUMBER GENERATOR

(71) Applicant: SEOUL NATIONAL UNIVERSITY R&DB FOUNDATION, Seoul (KR)

(72) Inventors: Woo Seok CHOI, Seoul (KR); Hyeri ROH, Seoul (KR)

(21) Appl. No.: 19/576,523

(22) Filed: Mar. 24, 2026

(30) Foreign Application Priority Data
Apr. 10, 2025 (KR) 10-2025-0046477

(51) Int. Cl. G06F 7/58; G06F 17/18

(52) U.S. Cl. CPC G06F 7/586; G06F 17/18

(57) ABSTRACT

An analog circuit-based random number generator according to an embodiment comprises a uniform random number generator configured such that output random number values have a uniform probability distribution, and an analog circuit configured to receive an output of the uniform random number generator and generate an output according to an inverse cumulative distribution function of a probability density function following a Laplace distribution.

### CROSS-REFERENCE TO RELATED APPLICATION

This application claims the benefit under 35 USC 119 (a) of Korean Patent Application No. 10-2025-0046477 filed on Apr. 10, 2025 in the Korean Intellectual Property Office, the entire disclosure of which is incorporated herein by reference for all purposes.

### BACKGROUND

### Technical Field

The present invention relates to an analog circuit-based random number generator.

### Background Art

Recently, in the fields of personal information protection and security applications, random number generators based on a Laplace distribution have been used as important components. In particular, in differential privacy algorithms, random numbers following a Laplace distribution are required in order to introduce randomness to sensitive data. In such applications, the required random numbers must simultaneously satisfy statistical accuracy as well as low power consumption, high processing efficiency, and precise probability distribution reproducibility at the hardware level, and thus the development of a random number generator structure that satisfies these requirements has become an important technical challenge.

A Laplace distribution has a probability density function (PDF) that has a high density around a mean and exponentially decreases toward both extremes. In order to generate such a probability distribution in hardware, an inverse cumulative distribution function (ICDF) is generally used. This is because random numbers following a desired Laplace distribution can be obtained by applying the ICDF to random numbers having a uniform distribution. A Laplace random number generator implements a bidirectional symmetric distribution based on this principle by inputting random numbers generated from a uniform random number generator (URNG) into an ICDF and adding a sign determination to an output thereof.

Conventional digital ICDF structures have been implemented through digital circuits. Although a digital method has an advantage in that precise numerical computation is possible, it has limitations in that it requires high-cost operations, a complex circuit configuration, and particularly a structure with high power consumption.

The present invention aims to provide a low-power analog circuit-based random number generator capable of solving an excessive power consumption problem and generating high-precision Laplace random numbers.

### SUMMARY

### Patent Literature

(Patent Document 1) Korean Registered Patent No. 10-2443658 (Title of the Invention: Varistor Element-Based Random Number Generator).

### Problem to be Solved

The present invention has been made to solve the above-described problems, and an object thereof is to provide a low-power analog circuit-based random number generator capable of minimizing power consumption while generating high-precision Laplace random numbers.

However, the technical problem to be achieved by the present embodiment is not limited to the technical problem described above, and other technical problems may exist.

### Means for Solving the Problem

As a technical means for solving the above-described technical problem, an analog circuit-based random number generator according to an embodiment of the present invention comprises: a uniform random number generator configured such that output random number values have a uniform probability distribution; and an analog circuit configured to receive an output of the uniform random number generator and generate an output according to an inverse cumulative distribution function of a probability density function following a Laplace distribution.

### Effects of the Invention

According to any one of the above-described means for solving the problems of the present invention, Laplace-distributed random numbers essential for differential privacy technology can be generated with low power through a CMOS circuit operating in a sub-threshold voltage region, and thus the present invention can be effectively utilized in application environments such as IoT devices or portable security devices in which power consumption is critical. In addition, since the present invention can secure higher linearity by adjusting the number of switches in a circuit, the present invention provides both scalability and practicality that enable flexible design modification according to required specifications.

### BRIEF DESCRIPTION OF THE DRAWINGS

FIG. 1 illustrates a configuration of an analog circuit-based random number generator according to an embodiment of the present invention.

FIGS. 2 and 3 illustrate configurations of an analog circuit according to an embodiment of the present invention, wherein FIG. 2 illustrates an overall configuration of the analog circuit, and FIG. 3 illustrates a configuration of a single circuit of the analog circuit.

FIGS. 4A and 4B illustrate experimental results indicating how well an analog circuit according to an embodiment of the present invention reproduces a logarithmic function, wherein FIG. 4A illustrates output characteristics before quantization, and FIG. 4B illustrates quantized output characteristics after passing through an analog-to-digital converter (ADC).

### DETAILED DESCRIPTION

Hereinafter, embodiments of the present invention will be described in detail with reference to the accompanying drawings so that those skilled in the art to which the present invention pertains can easily carry out the invention. However, the present invention may be implemented in various different forms and is not limited to the embodiments described herein. In addition, in the drawings, parts not related to the description are omitted in order to clearly describe the present invention, and similar reference numerals are assigned to similar parts throughout the specification.

Throughout the specification, when a part is described as being “connected” to another part, this includes not only a case in which the part is “directly connected” but also a case in which the part is “electrically connected” with another element interposed therebetween. In addition, when a part is described as “including” a component, this does not exclude other components unless otherwise stated, but means that other components may be further included.

In the present specification, the term “unit” includes a unit implemented by hardware, a unit implemented by software, and a unit implemented using both. In addition, one unit may be implemented using two or more pieces of hardware, and two or more units may be implemented by one piece of hardware. Meanwhile, the term “unit” is not limited to software or hardware, and a “unit” may be configured to be present in an addressable storage medium or configured to reproduce one or more processors. Accordingly, as an example, a “unit” includes components such as software components, object-oriented software components, class components, and task components, and includes processes, functions, attributes, procedures, subroutines, segments of program code, drivers, firmware, microcode, circuits, data, databases, data structures, tables, arrays, and variables. Functions provided within components and “units” may be combined into a smaller number of components and “units” or further separated into additional components and “units.” In addition, components and “units” may be implemented to reproduce one or more CPUs within a device.

Hereinafter, an embodiment of the present invention will be described in detail with reference to the accompanying drawings.

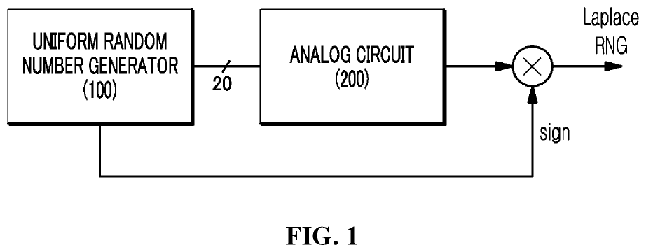

FIG. 1 illustrates a configuration of an analog circuit-based random number generator according to an embodiment of the present invention.

As illustrated in FIG. 1, the analog circuit-based random number generator of the present invention comprises a uniform random number generator (100) configured such that output random number values have a uniform probability distribution, and an analog circuit (200) configured to receive an output of the uniform random number generator (100) and generate an output according to an inverse cumulative distribution function of a probability density function following a Laplace distribution.

The uniform random number generator (100) may generate output random number values having a uniform probability distribution in a range of [0, 1]. The analog circuit (200) may implement an inverse cumulative distribution function (Inverse Cumulative Distribution Function, ICDF) of a probability density function following a Laplace distribution based on a characteristic in which a relationship between a drain-source current and a gate-source voltage in a sub-threshold voltage region of a MOSFET has a logarithmic function relationship.

By way of example, the analog circuit-based random number generator implements an output value following a Laplace distribution by using an output value of the uniform random number generator (100) as an input of an inverse cumulative distribution function of a Laplace distribution. More specifically, the uniform random number generator (100), as a URNG (Uniform Random Number Generator), outputs real values in the range of [0, 1] with a uniform probability distribution, and an output value u∈[0,1] thereof may be provided as an input to the analog circuit (200).

The analog circuit (200) may generate an output following a Laplace distribution by analogously implementing, for an input u, an inverse cumulative distribution function (ICDF) F⁻¹ (u)=λ ln(u) of a Laplace distribution Lap(λ). At this time, one most significant bit (MSB) of output values of the uniform random number generator (100) is used as a sign determination bit, thereby securing symmetry to a one-sided distribution generated by the analog circuit (200) and implementing a random number having a complete Laplace distribution.

In the related art, such ICDF operations have been implemented in a digital manner, resulting in high power consumption. However, in the present invention, by using the analog circuit (200) operating in a sub-threshold voltage region, power consumption of an entire circuit can be significantly reduced.

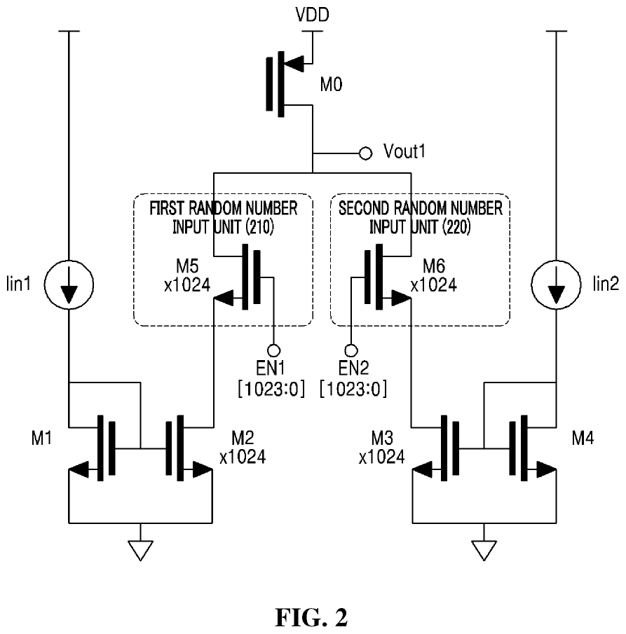

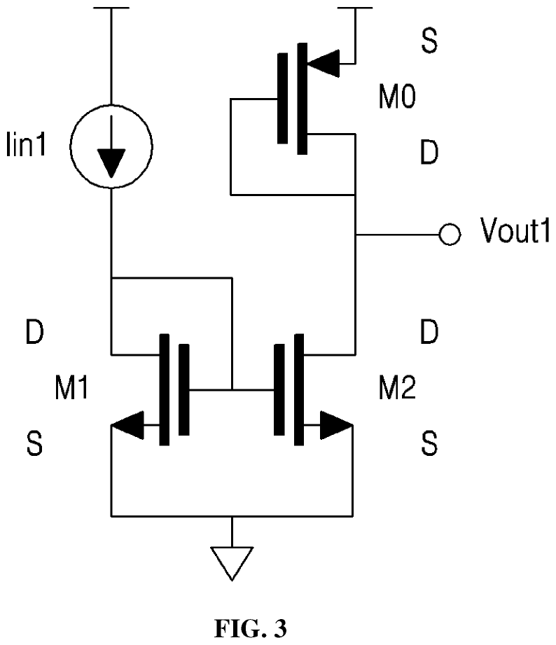

FIGS. 2 and 3 illustrate configurations of an analog circuit according to an embodiment of the present invention, wherein FIG. 2 illustrates an overall configuration of the analog circuit, and FIG. 3 illustrates a configuration of a single circuit of the analog circuit.

Referring to FIG. 2, the analog circuit (200) may be configured in a single structure in which only one random number input unit is arranged, or may be configured in a symmetrical structure in which a first random number input unit (210) is arranged on a left side and a second random number input unit (220) is arranged on a right side.

As an example, the analog circuit (200) configured in the single structure may include a first switching element (M0), the first random number input unit (210), a first current source (Iin1), a second switching element (M1), and a third switching element (M2).

The analog circuit (200) operates in a sub-threshold voltage region and may include: a first switching element (M0) having one terminal connected to a power supply and having a gate and the other terminal diode-connected; a first random number input unit (210) including a plurality of switching elements that are selectively switched in response to an output of the uniform random number generator (100) and are connected in parallel; a first current source (Iin1); a second switching element (M1) having one terminal connected to an output terminal of the first current source, the other terminal grounded, and having a gate and the one terminal diode-connected; and a third switching element (M2) arranged in a current mirror structure with the second switching element (M1), the third switching element (M2) having a gate connected to a gate of the second switching element (M1), the other terminal grounded, and one terminal connected to the other terminal of a switching element included in the first random number input unit (210). In addition, a node at which the other terminal of the first switching element (M0) and one terminal of a switching element included in the first random number input unit (210) are connected may be defined as an output node (Vout1). At this time, when operating in the sub-threshold voltage region, the first switching element (M0) has a characteristic in which a relationship between a drain-source current and a gate-source voltage has a logarithmic function relationship, and an output of the uniform random number generator (100) is input to gates of the switching elements included in the first random number input unit (210), such that the drain-source current of the first switching element (M0) may linearly increase according to the output of the uniform random number generator (100).

By way of example, the first random number input unit (210) may include 1024 switching elements, and the switching elements may be implemented to have identical sizes so that currents of identical magnitudes flow therethrough. In addition, each switching element may be selectively turned on/off according to an output signal of the uniform random number generator (100), and the output of the uniform random number generator (100) may have a thermometer code format.

That is, when operating in the sub-threshold voltage region, the first switching element (M0) may form a logarithmic function relationship as shown in Mathematical Equation 1 between a drain-source current (Ips) and a gate-source voltage (V_{GS}). In the analog circuit (200), switching elements of the first random number input unit (210) are controlled according to the output of the uniform random number generator (100), and as the drain-source current (I_{DS}) of the first switching element (M0) linearly increases, an output voltage V_{OUT1} (V_{DD}−V_{GS}) may also vary.

$${V}_{GS} = {V}_{TH} + n {V}_{T} ln ( \frac{{I}_{DS}}{{I}_{{D}_{0}}} ) \qquad < Mathematical Equation 1 >$$

By way of example, in the analog circuit (200) having a single-circuit configuration illustrated in FIG. 3, when a PMOS first switching element (M0) operates in a sub-threshold voltage region, an output voltage V_{OUT} (V_{DD}−V_{GS}) varies like a logarithmic function as a drain-source current (I_{DS}) linearly increases. Accordingly, by linearly increasing the drain-source current (I_{DS}) in the analog circuit (200) illustrated in FIG. 2, an inverse cumulative distribution function of a probability density function following a Laplace distribution can be implemented by applying a characteristic in which the output voltage V_{OUT} has an accurate logarithmic function relationship.

As another example, the analog circuit (200) configured in a symmetrical structure may include, in a left path, a first switching element (M0), a first random number input unit (210), a first current source (Iin1), a second switching element (M1), and a third switching element (M2), and may include, in a right path, a second random number input unit (220), a second current source (Iin2), a fourth switching element (M3), and a fifth switching element (M4). At this time, a node at which the other terminal of the first switching element (M0) and one terminal of switching elements (M5, M6) included in the first random number input unit (210) and the second random number input unit (220) are connected may be defined as an output node (Vout1).

In addition, an output of the uniform random number generator (100) may be input to a gate of a switching element (M5) included in the first random number input unit (210) through an EN1 signal, and an output of the uniform random number generator (100) may be input to a gate of a switching element (M6) included in the second random number input unit (220) through an EN2 signal. At this time, the switching elements (M5, M6) receive the output of the uniform random number generator (100) in a thermometer code format and are selectively activated, thereby allowing a drain-source current of the first switching element (M0) to linearly increase.

Meanwhile, a thermometer code is one of methods for representing a digital value and has a form in which ‘1’s appear consecutively. For example, a 3-bit thermometer code is represented as ‘000’, ‘001’, ‘011’, and ‘111’, and is used in a digital-to-analog converter (DAC), in which each bit controls one switching element to adjust an output current. Accordingly, since an output current increases in proportion to a number of activated switching elements of the first random number input unit (210) or the second random number input unit (220), an amount of current can be linearly adjusted.

In addition, in the analog circuit (200) having the symmetrical structure, an output of upper bits among outputs of the uniform random number generator (100) may be input to the second random number input unit (220), and an output of lower bits among the outputs of the uniform random number generator (100) may be input to the first random number input unit (210).

Switching elements included in the first random number input unit (210) are implemented to have identical sizes so that currents of identical magnitudes flow therethrough, switching elements included in the second random number input unit (220) are implemented to have identical sizes so that currents of identical magnitudes flow therethrough, and switching elements included in the second random number input unit (220) may be larger than switching elements included in the first random number input unit (210).

By way of example, the first random number input unit (210) and the second random number input unit (220) may each include 1024 switching elements (M5, M6), and a switching element (M6) included in the second random number input unit (220) may be 1000 times larger than a switching element (M5) included in the first random number input unit (210).

Meanwhile, when an output of the uniform random number generator (100) is 20 bits, if the output is directly used as an input of the analog circuit (200), more than one million combinations of I_{DS} and switching elements are required, which results in inefficiency in circuit area.

In order to solve this problem, in the present invention, a thermometer code may be applied by dividing an input value as in the EN1 and EN2 signals illustrated in FIG. 2. When a 20-bit input is divided into two 10-bit segments and a thermometer code is applied, each segment is represented from 0 to 1023, and the same control effect can be obtained while reducing the total number of switching elements. That is, turning on 1024 switching elements (M5) included in the first random number input unit (210) and turning on one switching element (M6) included in the second random number input unit (220) can implement the same output characteristic. Accordingly, current control is possible by dividing the entire input value at high resolution, and efficiency and accuracy of the circuit can be improved.

Meanwhile, since the first switching element (M0) processes only a very small current as it operates in a sub-threshold voltage region, a current I_{E1} flowing through the first switching element (M0) should be very small, and may be significantly affected by leakage current caused by a connection between a drain and a gate of the second switching element (M1).

In order to reduce the influence of such leakage current, in the present invention, an area ratio of the second switching element (M1) to the third switching element (M2) may be set to 1000:1. At this time, the area ratio refers to a W/L ratio of a MOSFET, which means a ratio of a channel width (W) to a channel length (L).

In addition, since a current I_{E2} of the second random number input unit (220) has a larger current than I_{E1}, an area ratio of the fifth switching element (M4) to the fourth switching element (M3) may also be set to 10:1 to stably process a large current (I_{E2}).

In addition, since the first switching element (M0) operates in a sub-threshold voltage region and processes only a very small current, a W/L ratio may be set to be large to a level at which current can be stably secured in the sub-threshold region.

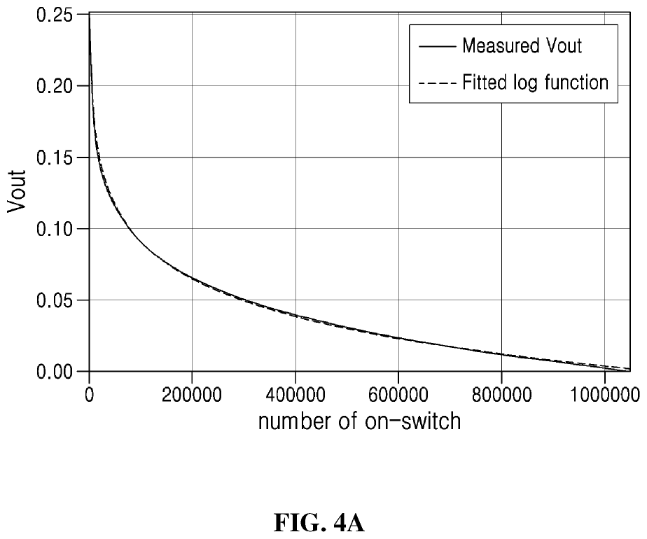

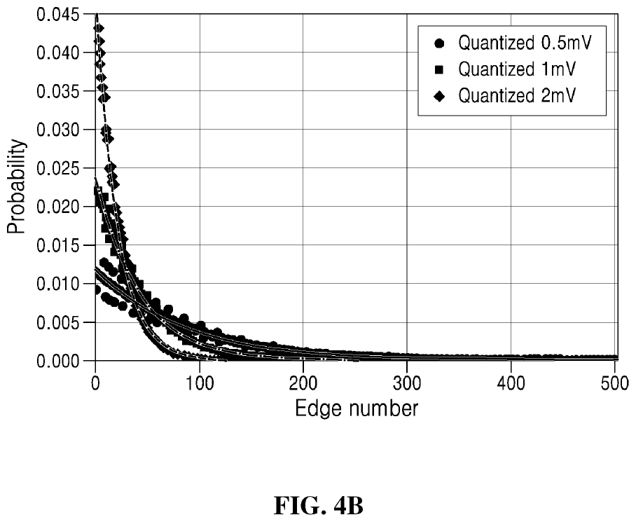

FIGS. 4A and 4B illustrate experimental results indicating how well an analog circuit according to an embodiment of the present invention reproduces a logarithmic function.

FIG. 4A illustrates output characteristics before quantization, and FIG. 4B illustrates quantized output characteristics after passing through an analog-to-digital converter (ADC), and show simulation results on logarithmic function reproducibility obtained by designing the analog circuit according to an embodiment of the present invention using a 28 nm process.

Referring to FIGS. 4A and 4B, an output voltage is calculated as V_{OUT}=V_{OUT1}−V_{OUT2}, and measured output voltages are shown to have a high correlation with a logarithmic function. An R-square value with respect to the logarithmic function is calculated as 0.99927, indicating that logarithmic characteristics are excellently reproduced.

Such logarithmic function reproducibility may vary depending on a resolution of an analog-to-digital converter (ADC) connected at a subsequent stage. In the present embodiment, the resolution of the ADC is set to 9 bits, 8 bits, and 7 bits, and quantization of 0.5 mV, 1 mV, and 2 mV is performed for each V_{OUT}, respectively. As a result, R-square values for logarithmic function approximation are shown as 0.99613, 0.99284, and 0.98271, respectively, thereby confirming a variation trend of reproducibility according to the ADC resolution.

Meanwhile, while a conventional digital circuit-based ICDF (Inverse Cumulative Distribution Function) generator consumes approximately 158.3 μW of power, the ICDF operation analog circuit (200) according to the present invention operates in a sub-threshold voltage region and thus consumes only approximately 26.3238 μW of very low power, and when the uniform random number generator (100) is implemented as a digital circuit, it is shown to consume approximately 8.0065 μW of power. Therefore, power consumption of the analog-based random number generator according to the present invention is approximately 34.3303 μW, and it can be confirmed that power consumption is significantly reduced compared to the related art.

The method according to an embodiment of the present invention may also be implemented in a form of a recording medium including computer-executable instructions, such as program modules executed by a computer. A computer-readable medium may be any available medium that can be accessed by a computer, and includes all of volatile and non-volatile media and removable and non-removable media. In addition, the computer-readable medium may include a computer storage medium. The computer storage medium includes all of volatile and non-volatile media and removable and non-removable media implemented by any method or technology for storage of information such as computer-readable instructions, data structures, program modules, or other data.

The apparatus and method of the present invention have been described in connection with specific embodiments, but some or all of components or operations thereof may be implemented using a computer system having a general-purpose hardware architecture.

The above description of the present invention is for illustrative purposes, and those skilled in the art to which the present invention pertains will understand that various modifications can be easily made in other specific forms without changing the technical spirit or essential characteristics of the present invention. Therefore, the embodiments described above should be understood in all respects as illustrative and not restrictive. For example, each component described as a single form may be implemented in a distributed manner, and likewise, components described as being distributed may also be implemented in a combined form.

The scope of the present invention is indicated by the claims set forth below rather than by the foregoing detailed description, and all changes or modifications derived from the meaning and scope of the claims and equivalent concepts thereof should be construed as being included within the scope of the present invention.

### DESCRIPTION OF REFERENCE NUMERALS

100: Uniform random number generator
200: Analog circuit
210: First random number input unit
220: Second random number input unit

What is claimed is:

1. An analog circuit-based random number generator comprising:
a uniform random number generator configured such that output random number values have a uniform probability distribution; and
an analog circuit configured to receive an output of the uniform random number generator and generate an output according to an inverse cumulative distribution function of a probability density function following a Laplace distribution.

2. The analog circuit-based random number generator of claim 1,
wherein the analog circuit implements the inverse cumulative distribution function of the probability density function following the Laplace distribution based on a characteristic in which a relationship between a drain-source current and a gate-source voltage of a MOSFET in a sub-threshold voltage region has a logarithmic function relationship.

3. The analog circuit-based random number generator of claim 1,
wherein the analog circuit comprises:
a first switching element (M0) that operates in a sub-threshold voltage region, has one terminal connected to a power supply, and has a gate and the other terminal diode-connected;
a first random number input unit in which a plurality of switching elements that are selectively switched in response to an output of the uniform random number generator are connected in parallel;
a first current source;
a second switching element (M1) having one terminal connected to an output terminal of the first current source, the other terminal grounded, and having a gate and the one terminal diode-connected; and
a third switching element (M2) arranged in a current mirror structure with the second switching element (M1), the third switching element (M2) having a gate connected to the gate of the second switching element (M1), the other terminal grounded, and one terminal connected to the other terminal of a switching element included in the first random number input unit,
wherein a node at which the other terminal of the first switching element (M0) and one terminal of a switching element included in the first random number input unit are connected is defined as an output node,
wherein, when operating in the sub-threshold voltage region, the first switching element (M0) has a characteristic in which a relationship between a drain-source current and a gate-source voltage has a logarithmic function relationship,
wherein an output of the uniform random number generator is input to gates of switching elements included in the first random number input unit, and
wherein the drain-source current of the first switching element (M0) linearly increases according to the output of the uniform random number generator.

4. The analog circuit-based random number generator of claim 3,
wherein the analog circuit further comprises:
a second random number input unit in which a plurality of switching elements that are selectively switched in response to the output of the uniform random number generator are connected in parallel;
a second current source;
a fifth switching element (M4) having one terminal connected to an output terminal of the second current source, the other terminal grounded, and having a gate and the one terminal diode-connected; and
a fourth switching element (M3) arranged in a current mirror structure with the fifth switching element (M4), the fourth switching element (M3) having a gate connected to a gate of the fifth switching element (M4), the other terminal grounded, and one terminal connected to the other terminal of a switching element included in the second random number input unit,
wherein a node at which the other terminal of the first switching element (M0) and one terminal of a switching element included in the second random number input unit are connected is defined as an output node,
wherein an output of the uniform random number generator is input to gates of switching elements included in the second random number input unit, and
wherein an output of upper bits among outputs of the uniform random number generator is input to the second random number input unit, and an output of lower bits among the outputs of the uniform random number generator is input to the first random number input unit.

5. The analog circuit-based random number generator of claim 4,
wherein the output of the uniform random number generator input to the first random number input unit or the second random number input unit has a thermometer code format.

6. The analog circuit-based random number generator of claim 4,
wherein switching elements included in the first random number input unit are implemented to have identical sizes such that currents of identical magnitudes flow therethrough,
wherein switching elements included in the second random number input unit are implemented to have identical sizes such that currents of identical magnitudes flow therethrough, and
wherein a switching element included in the second random number input unit is larger than a switching element included in the first random number input unit.

7. The analog circuit-based random number generator of claim 4,
wherein the first random number input unit and the second random number input unit each include 1024 switching elements, and
wherein a switching element included in the second random number input unit is 1000 times larger than a switching element included in the first random number input unit.
